(19) United States
(12) Patent Application Publication
(10) Pub. No.: US 2010/0275410 A1
(43) Pub. Date: Nov. 4, 2010

(54) AUTOMATIC POSITIONING HINGE

(75) Inventor: Wei-Hung CHANG, Taichung (TW)

Correspondence Address: PATENTTM.US, P. O. BOX 82788, PORTLAND, OR, 97282-0788, US

(73) Assignee: DOOR & WINDOW HARDWARE CO., Taichung (TW)

(21) Appl. No.: 12/434,559

(22) Filed: May 1, 2009

(51) Int. Cl. E05F 1/08

(52) U.S. Cl. 16/277

(57) ABSTRACT

A positioning hinge has a body, a pivotal shaft, a securing base and an automatic closing device. The pivotal shaft is mounted in the body and has at least one positioning face defined in the pivotal shaft. The securing base is connected pivotally to the body with the pivotal shaft. The automatic closing device is connected to the pivotal shaft and has at least one cylinder provided with pressured air. The at least one cylinder connects to and pushes the at least one positioning face on the pivotal shaft to provide an automatic closing force to the door panel with the pressured air when the pressured air in the at least one cylinder is compressed. Accordingly, the positioning hinge can automatically close a door panel slowly and smoothly with the pneumatic pressures provided by the cylinders.

### BACKGROUND OF THE INVENTION

1. Field of the Invention

The present invention relates to a positioning hinge, and more particularly to a positioning hinge that can automatically close a door panel slowly and smoothly.

2. Description of Related Art

To automatically close a door panel, a door hinge is always provided with an automatic closing device. A conventional automatic closing device has a spring to provide a recoil force to a pivotal shaft to make the door panel closing automatically after the door panel being opened.

However, the recoil force provided by the spring is based on the compression of the spring, so the recoil force as the spring being little compressed is different from as the spring being largely compressed. Therefore, the recoil force provided by the spring on the conventional automatic closing device is very difficult to control. When the spring is little compressed, the recoil force may be not enough to push the door panel to the closed position actually.

In addition, when the spring pushes the door panel to pivotally rotation rapidly, the door panel will bump with the door frame or door lock heavily to cause big noise or the lock being damaged. Furthermore, the spring easily loses its elasticity due to long term of use, and the spring cannot provide enough recoil force to push the door panel to the closed condition.

To overcome the shortcomings, the present invention tends to provide a positioning hinge to mitigate or obviate the aforementioned problems.

### SUMMARY OF THE INVENTION

The main objective of the invention is to provide a positioning hinge that can automatically close a door panel slowly and smoothly. The positioning hinge comprises a body, a pivotal shaft, a securing base and an automatic closing device. The pivotal shaft is mounted in the body and has at least one positioning face defined in the pivotal shaft. The securing base is connected pivotally to the body with the pivotal shaft. The automatic closing device is connected to the pivotal shaft and has at least one cylinder provided with pressured air. The at least one cylinder connects to and pushes the at least one positioning face on the pivotal shaft to provide an automatic closing force to the door panel with the pressured air when the pressured air in the at least one cylinder is compressed.

Other objects, advantages and novel features of the invention will become more apparent from the following detailed description when taken in conjunction with the accompanying drawings.

### BRIEF DESCRIPTION OF THE DRAWINGS

FIG. 1 is a side view of a door panel provided with two automatic positioning hinges in accordance with the present invention;

FIG. 2 is a perspective view of the automatic positioning hinge in FIG. 1;

FIG. 3 is an exploded perspective view of the positioning hinge in FIG. 2;

FIG. 4 is a cross sectional side view of the positioning hinge in FIG. 2;

FIG. 5 is a cross sectional top view of the positioning hinge in FIG. 2;

FIG. 6 is an operational cross sectional top view of the positioning hinge in FIG. 2;

FIG. 7 is a side view of a door panel provided with two alternative embodiments of automatic positioning hinges in accordance with the present invention;

FIG. 8 is a perspective view of the automatic positioning hinge in FIG. 7;

FIG. 9 is an exploded perspective view of the positioning hinge in FIG. 7; and

FIG. 10 is a cross sectional side view of the positioning hinge in FIG. 7.

### DETAILED DESCRIPTION OF PREFERRED EMBODIMENT

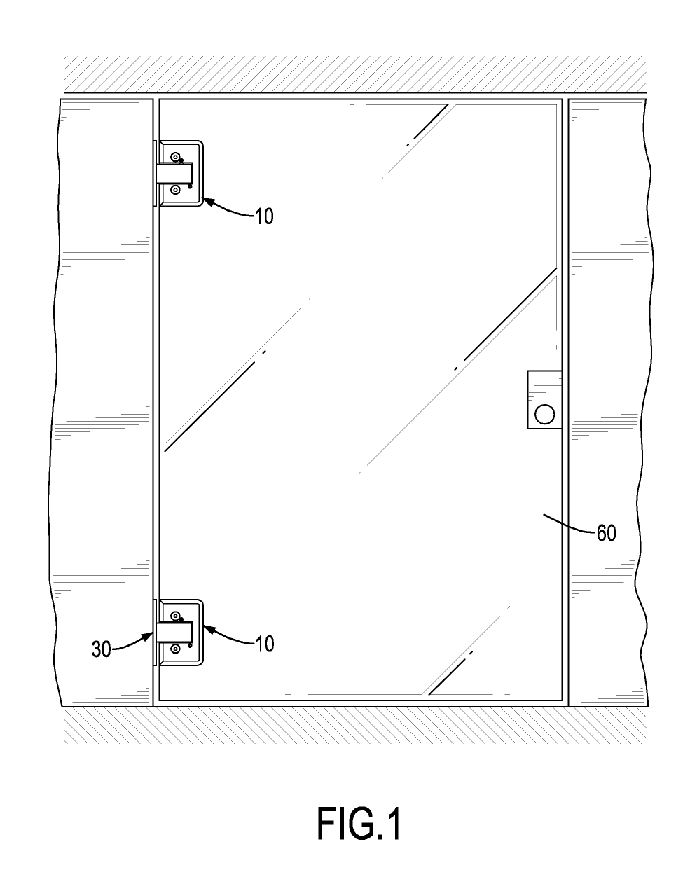

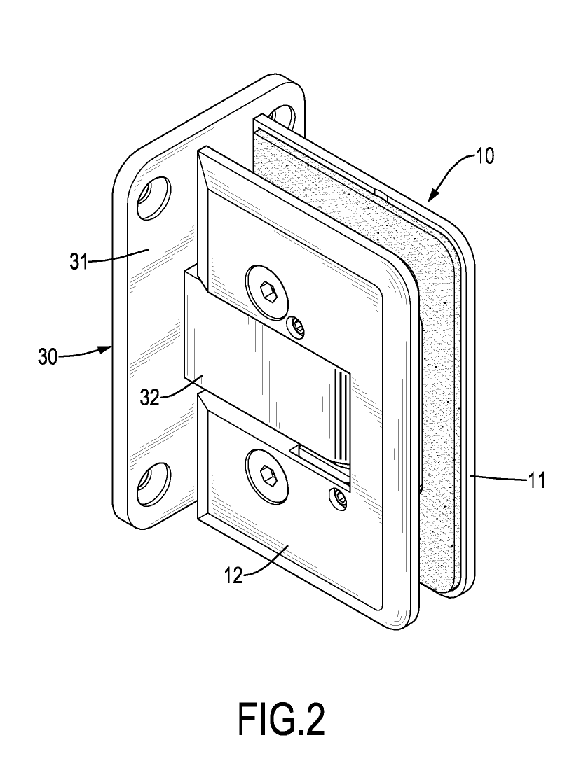

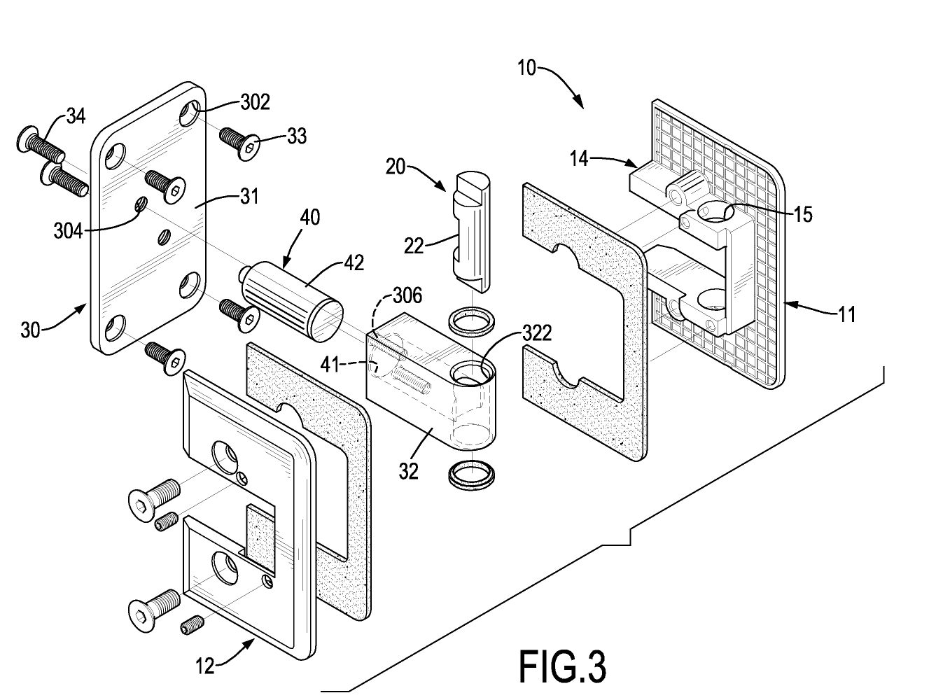

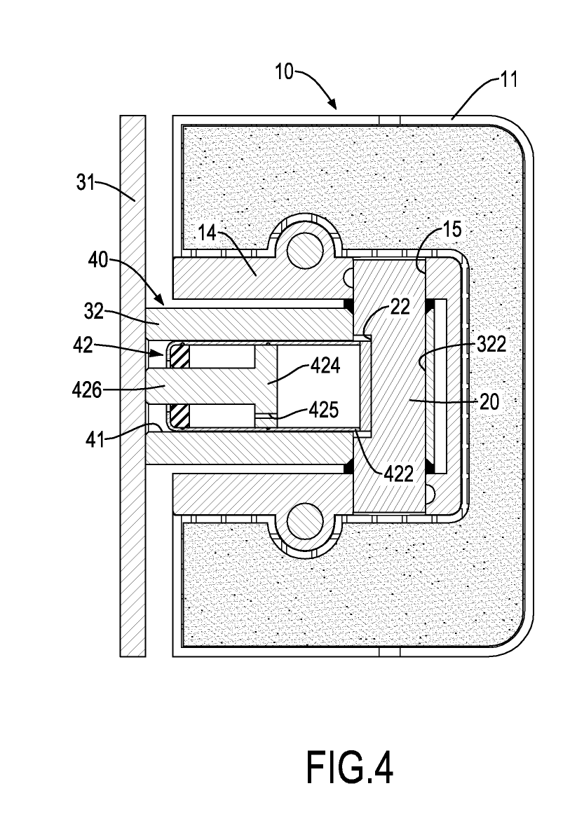

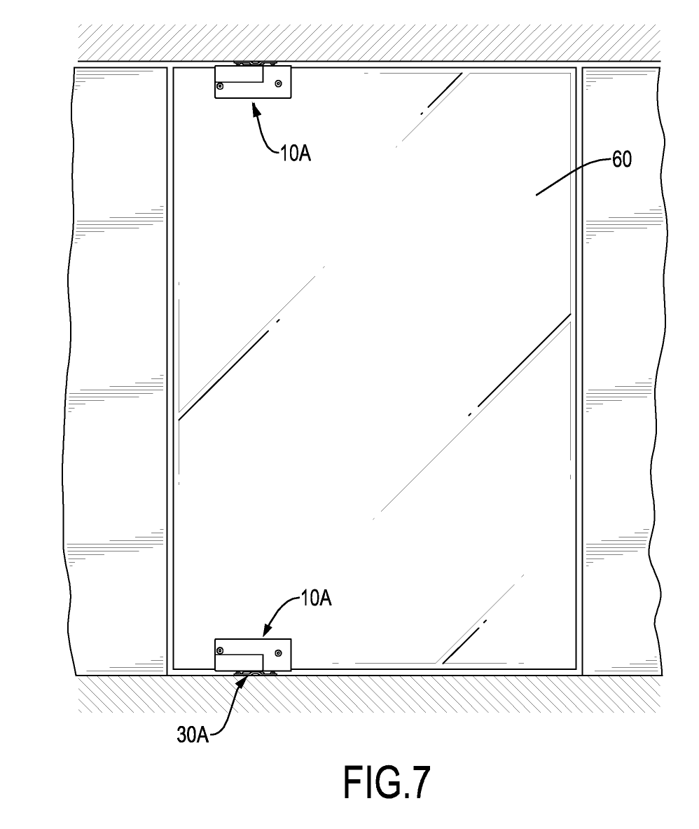

With reference to FIGS. 1 to 4 and 7, a positioning hinge in accordance with the present invention is mounted on a door panel (60), may be at the top, the bottom or one side edge of the door panel (60) and comprises a body (10,10A), a pivotal shaft (20), a securing base (30,30A) and automatic closing device (40).

With reference to FIGS. 1 to 4, the body (10) is attached to and holds the door panel (60), may be U-shaped and comprises a holding base (11) and a clamping base (12). The holding base (11) and the clamping base (12) are separately combined with each other to form a gap between the holding and clamping bases (11,12) for holding a corresponding edge of the door panel (60). The holding base (11) may be U-shaped and has a pivotal bracket (14) formed on the holding base (11) at a side facing the clamping base (12). The pivotal bracket (14) may be U-shaped and has a pivotal hole (15) defined in the pivotal bracket (14). The clamping base (12) has a shape corresponding to that of the holding base (11) and may also be U-shaped.

The pivotal shaft (20) is mounted in the body (10), is mounted in the pivotal hole (15) in the pivotal bracket (14) on the holding base (11) and has at least one positioning face (22) defined in the pivotal shaft (20). In the preferred embodiment, the pivotal shaft (20) has a single positioning face (22).

The securing base (30) is connected pivotally to the body (10) with the pivotal shaft (20). In the preferred embodiment, the securing base (30) comprises a securing board (31) and a shaft base (32). The securing board (31) is attached securely to a door frame or a wall. The securing board (31) has multiple through holes (302) and connecting holes (304) defined through the securing base (32). Multiple fasteners (33), such as bolts are mounted through the through holes (302) and are mounted into the door frame or the wall to securely attach the securing board (31) onto the door frame or the wall.

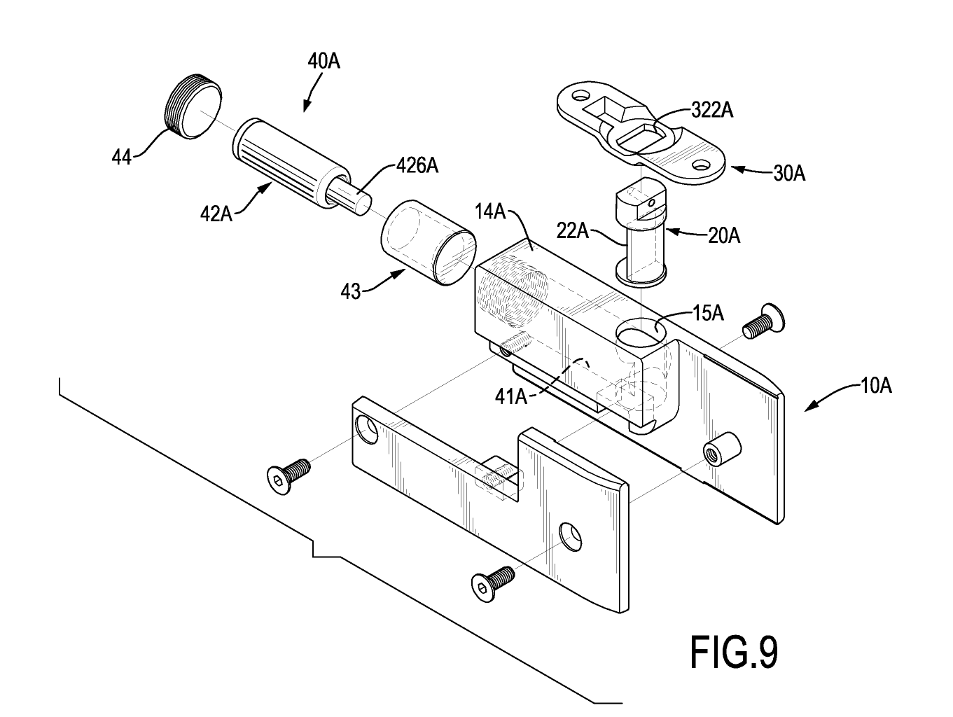

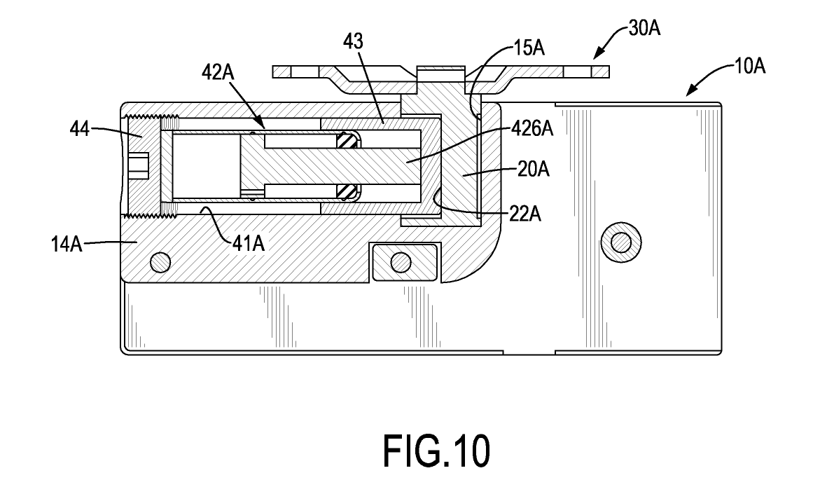

The shaft base (32) is connected securely to the securing board (31), is held in the U-shaped holding and clamping bases (11,12) of the body (10) and has a shaft hole (322) and multiple threaded holes (306). The shaft hole (322) is defined through the shaft base (32) and corresponds to and communicates with the pivotal hole (15) in the body (10). The pivotal shaft (20) is held in the shaft hole (322) and two ends of the pivotal shaft (20) extend out of the shaft hole (322) and into the pivotal hole (15) in the body (10). In the preferred embodiment, the pivotal shaft (20) is securely mounted in the pivotal hole (15) in the body (10) and rotatably mounted in the shaft hole (322) in the securing base (30). In the alternative embodiment, the pivotal shaft (20A) is rotatably mounted in the pivotal hole (15A) in the body (10A) and securely connected to the shaft hole (322A) in the securing base (30A) as shown in FIGS. 8 to 10. The securing base (30A) may be a single board with a non-circular hole engaging one end of the pivotal shaft (20A).

The threaded holes (306) are defined in one side of the shaft base (32) and align respectively with the connecting holes (304) in the securing board (31). Multiple fasteners (34), such as bolts are mounted respectively through the connecting holes (304) and screwed respectively into the threaded holes (306) in the shaft base (32) to securely connect the shaft base (32) to the securing board (31).

The automatic closing device (40) is connected to the pivotal shaft (20) and comprises at least one cylinder (42). In the preferred embodiment in which the pivotal shaft (20) is rotatably mounted in the shaft hole (322) in the securing base (30), the automatic closing device (40) is mounted in the securing base (30) and is mounted in the shaft base (32). To hold the at least one cylinder (32) in the shaft base (32), the shaft base (32) has at least one cylinder hole (41) defined in the shaft base (32) at a side in which the threaded holes (306) are defined. Each cylinder hole (41) communicates with the shaft hole (322) and holds a corresponding cylinder (42) inside. Each cylinder (42) is provided and filled with pressured air and is connected to and pushes a corresponding positioning face (22) on the pivotal shaft (20). Consequently, an automatic closing force can be provided to the pivotal shaft (20) and the door panel (60) with the pneumatic pressure of the pressured air when the pressured air in the at least one cylinder (42) is compressed. The compressed air in each cylinder (42) can be nitrogen or inert gas. In addition, the automatic closing device (40) may have a single cylinder (42) corresponding to the single positioning face (22) on the pivotal shaft (20), multiple cylinders (42) corresponding to the single positioning face (22) or multiple cylinders (42) corresponding respectively to multiple positioning faces (22).

In the alternative embodiment in which the pivotal shaft (20A) is rotatably mounted in the pivotal hole (15A) in the body (10A) as shown in FIGS. 8 to 10, the automatic closing device (40A) is mounted in the body (10A) and is mounted in the pivotal bracket (14A) on the body (10A).

Each cylinder (42) of the automatic closing device (40) comprises a housing (422), a piston (424) and a piston rod (426). The housing (422) is mounted in the cylinder hole (41) in the shaft base (32) and has a chamber defined in the housing (422) and filled with the pressured air. The piston (424) is slidably mounted in the chamber to divide the chamber into two pressure spaces. The piston rod (426) is attached to the piston (424) and protrudes out from the housing (422). In the preferred embodiment, the housing (422) of each cylinder (42) abuts directly with the corresponding positioning face (22) on the pivotal shaft (20). In the alternative embodiment, each cylinder (42A) abuts with the corresponding positioning face (22A) with the piston rod (426A) directly or via a pushing element (43). In addition, a plug (44) with thread is screwed with the cylinder hole (41A) defined in the pivotal bracket (14A) to close the cylinder hole (41A) for holding the cylinder (42A) with the pushing element (43) inside the cylinder hole (41A).

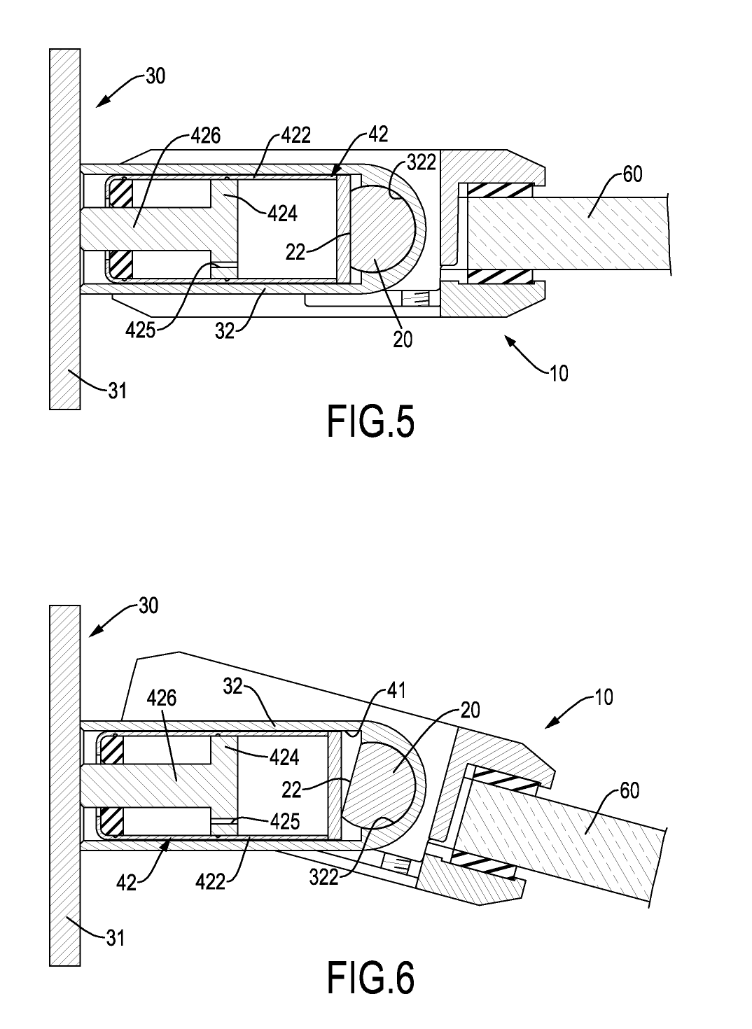

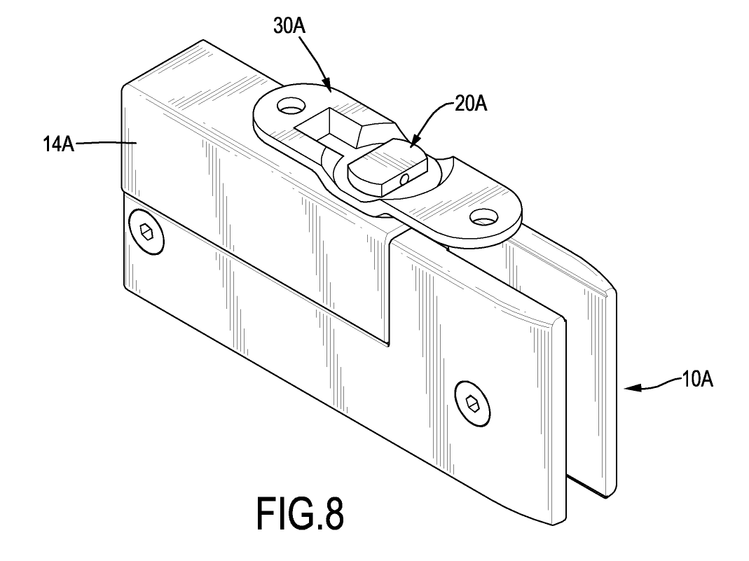

With reference to FIGS. 5 and 6, when the door panel (60) is pivoted and opened, the body (10) will be pivoted relative to the securing base (30) and the pivotal shaft (20) is rotated in the shaft hole (322) in the shaft base (32). With the rotation of the pivotal shaft (20), the housing (422) or the piston rod (426) of the at least one cylinder (42) will be pushed against by the pivotal shaft (20) to move relative to the cylinder hole (41). With the relative movement of the housing (422) and the piston (424), the piston (424)/housing (422) is moved relative to the housing (422)/piston (424) to make one of the pressure spaces being compressed. Thus, the pressure in the compressed pressure space is increased and larger than that in the other pressure space.

When the door panel (60) is released, the larger pressure in the compressed pressure space provides a recoil force to the housing (422) or the piston (424) to push the housing (422) or the piston (424) to move backward until the pressures in the spaces are balanced. Consequently, the cylinder (42) can push the pivotal shaft (20) to rotate in reverse, such that the door panel (60) can be automatically closed.

With the pneumatic pressure differences of the pressured air between the pressure spaces in the cylinder (42), a recoil force is provided to close the door panel (60) automatically. The reaction time of the pneumatic pressure balance between the two pressure spaces is slow, so the door panel (60) can be closed at a slow speed to keep the door panel (60) from bumping with the door frame or another objects. The piston (424) may have a tiny passage (425) defined through the piston (424) and communicating with the pressure spaces. With the arrangement of the tiny passage (425), an airflow with a buffering effect is provided between the pressure spaces during the pressure balance process to make the movement of the piston (424) smoother. Accordingly, the pneumatic recoil force provided by the automatic closing device (40) is tender and smooth. In addition, the pneumatic cylinder (42) of the automatic closing device (40) does not have elasticity loss problem as springs, so the useful life of the automatic closing device (40) in accordance with the present invention is prolonged. The door panel (60) can still be precisely closed to a closed condition even after a long term of use.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A positioning hinge comprising:
a body for being attached to a door panel;
a pivotal shaft mounted in the body and having at least one positioning face defined in the pivotal shaft;
a securing base connected pivotally to the body with the pivotal shaft; and
an automatic closing device connected to the pivotal shaft and having at least one cylinder provided with pressured air and connecting to and pushing the at least one positioning face on the pivotal shaft to provide an automatic closing force to the door panel with the pressured air when the pressured air in the at least one cylinder is compressed.

2. The positioning hinge as claimed in claim 1, wherein the pivotal shaft is mounted securely in the body and rotatably mounted in the securing base to pivotally connect the securing base with the body via the pivotal shaft.

3. The positioning hinge as claimed in claim 2, wherein the automatic closing device is mounted in the securing base.

4. The positioning hinge as claimed in claim 3, wherein each one of the at least one cylinder of the automatic closing device comprises
a housing having a chamber defined in the housing and filled with the pressured air;
a piston slidably mounted in the chamber to divide the chamber into two pressure spaces; and
a piston rod attached to the piston and protruding out from the housing.

5. The positioning hinge as claimed in claim 4, wherein the housing of each one of the at least one cylinder of the automatic closing device abuts with a corresponding one of the at least one positioning face on the pivotal shaft with.

6. The positioning hinge as claimed in claim 5, wherein the securing base comprises
a securing board; and
a shaft base connected securely to the securing board and having
a shaft hole defined through the shaft base to rotatably hold the pivotal shaft inside; and
at least one cylinder hole defined in the shaft base and communicating with the shaft hole to hold the at least one cylinder inside respectively.

7. The positioning hinge as claimed in claim 6, wherein
the securing board of the securing base further has
multiple through holes defined through the securing base; and
multiple connecting holes defined through the securing base;
the shaft base of the securing base further has multiple threaded holes defined in one side of the shaft base and aligning respectively with the connecting holes in the securing board;
multiple fasteners are mounted respectively through the connecting holes and screwed respectively into the threaded holes in the shaft base to securely connect the shaft base to the securing board; and
the at least one cylinder hole is defined in the shaft base at the side in which the threaded holes are defined.

8. The positioning hinge as claimed in claim 7, wherein the body comprises
a holding base comprising a pivotal bracket formed on the holding base and a pivotal hole defined in the pivotal bracket and corresponding to and communicating with the shaft hole in the securing base to securely hold the pivotal shaft inside; and
a clamping base separately connected to the holding base to define a gap between the holding base and the clamping base for holding the door panel in the gap.

9. The positioning hinge as claimed in claim 1, wherein each one of the at least one cylinder of the automatic closing device comprises
a housing having a chamber defined in the housing and filled with the pressured air;
a piston slidably mounted in the chamber to divide the chamber into two pressure spaces; and
a piston rod attached to the piston and protruding out from the housing.

10. The positioning hinge as claimed in claim 9, wherein the housing of each one of the at least one cylinder of the automatic closing device abuts with a corresponding one of the at least one positioning face on the pivotal shaft with.

11. The positioning hinge as claimed in claim 1, wherein the automatic closing device is mounted in the securing base.

12. The positioning hinge as claimed in claim 11, wherein the securing base comprises
a securing board; and
a shaft base connected securely to the securing board and having
a shaft hole defined through the shaft base to rotatably hold the pivotal shaft inside; and
at least one cylinder hole defined in the shaft base and communicating with the shaft hole to hold the at least one cylinder inside respectively.

13. The positioning hinge as claimed in claim 12, wherein
the securing board of the securing base further has
multiple through holes defined through the securing base; and
multiple connecting holes defined through the securing base;
the shaft base of the securing base further has multiple threaded holes defined in one side of the shaft base and aligning respectively with the connecting holes in the securing board;
multiple fasteners are mounted respectively through the connecting holes and screwed respectively into the threaded holes in the shaft base to securely connect the shaft base to the securing board; and
the at least one cylinder hole is defined in the shaft base at the side in which the threaded holes are defined.

14. The positioning hinge as claimed in claim 12, wherein the body comprises
a holding base comprising a pivotal bracket formed on the holding base and a pivotal hole defined in the pivotal bracket and corresponding to and communicating with the shaft hole in the securing base to securely hold the pivotal shaft inside; and
a clamping base separately connected to the holding base to define a gap between the holding base and the clamping base for holding the door panel in the gap.
